(19) United States
(12) Patent Application Publication
(10) Pub. No.: US 2007/0070490 A1
(43) Pub. Date: Mar. 29, 2007

(54) Optical communication device provided with a reflector and method for forming a reflector in an optical communication device

(75) Inventors: Yukito Tsunoda, Kawasaki (JP); Hiroshi Miyata, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/312,769

(22) Filed: Dec. 21, 2005

(30) Foreign Application Priority Data
Sep. 28, 2005 (JP) 2005-281002

(51) Int. Cl. G02F 1/33; G02F 1/01; G02B 26/08; G02F 1/295

(52) U.S. Cl. 359/308; 385/47; 359/237; 359/238; 359/240; 359/285; 359/298; 359/305; 385/1; 385/2; 385/4; 385/8; 385/9

(57) ABSTRACT

An optical communication device of the invention includes a reflector for reflecting the light that has reached one end surface of a waveguide chip to turn the optical path of the light. The reflector includes a transparent thin film layer formed on one end surface of the waveguide chip by using a material to which a metal that forms an intermetallic compound or the like with Au is added to a substance that is transparent to the light that propagates through the waveguide, as well as an Au thin film layer formed on the front surface of the transparent thin film layer. This allows formation of a reflector having an Au thin film layer as a reflecting surface in an optical medium with high adhesion strength. Thus, an optical communication device can be provided having a high reliability with little loss.

### BACKGROUND OF THE INVENTION

(1) Field of the Invention

The present invention relates to an optical communication device provided with a reflector for reflecting the light that has reached an end surface of an optical medium to turn the optical path thereof, and a method of forming a reflector in an optical communication device. Particularly, the invention relates to a technique for forming a reflector having a gold (Au) thin film as a reflecting surface with high adhesion strength.

(2) Related Art

In recent years, techniques using light are widely used. Among these, a communication technique using light is rapidly developing. Though a further multiple functionality, multiple-stage connection of plural functional sections, and the like are essential in devices used in the field of optical communication, there is also a high demand on a technique for scale reduction of devices.

As one of the conventional techniques related to scale reduction of optical communication devices, a technique for achieving scale reduction such as shown in FIG. 6 is known in the art. Referring to FIG. 6, in a waveguide chip 100 having a plurality of functional device sections 101, 102 that are connected in series, the light that is output from the functional device section 101 is reflected by a reflector 103 formed on a chip end surface to be sent to the functional device section 102, thereby reducing the total length of the waveguide chip 100 to achieve scale reduction. Here, in FIG. 6, acousto-optic tunable filters (AOTF) are shown as one example of the functional device sections 101, 102; however, the technique for scale reduction using a reflector is effective also in a case where various functional device sections other than the AOTF are connected in series.

As a material for a reflector used for scale reduction of optical communication devices such as described above, aluminum (Al), silver (Ag), gold (Au), or the like has been generally used. However, a reflector using Al raises a problem of causing loss of light because some absorption of light occurs in reflecting the light. Also, a reflector using Ag has a drawback in that, since Ag is a material that is liable to be oxidized though little absorption occurs in reflecting the light, loss of light occurs due to decrease in the reflectivity according as the oxidation proceeds.

On the other hand, a reflector using Au has an advantage in that a reflector with little loss can be formed because no absorption of light occurs by reflection in an infrared region, and also stable reflection characteristics can be obtained because Au undergoes no deterioration by oxidation. However, a reflector in which an Au thin film has been formed directly on an end surface of a waveguide chip raises a problem in that exfoliation of the Au thin film is liable to occur because the adhesion strength of the Au thin film to the waveguide chip is weak.

As a conventional technique for improving the adhesion strength of the Au thin film to the end surface of the waveguide chip, a method is known in which a metal thin film such as titanium (Ti) is formed as an underlying layer between the chip end surface and the Au thin film. Further, though the usage is different from that of a reflector used for the aforementioned scale reduction of optical communication devices such as shown in FIG. 6, there is a method of forming a thin film of silicon oxide (SiO₂) or aluminum oxide (Al₂O₃) as an underlying layer of an Au thin film in a mirror used for a high-output laser or a reflecting mirror used for an infrared heater (For example, see Japanese Patent Application Laid-Open (JP-A) Nos. 11-307845 and 10-197706).

However, with the conventional technique that aims at improvement of the adhesion strength of an Au thin film by using a metal thin film such as Ti as an underlying layer, the light that is emitted from the end surface of the waveguide chip reaches the Au thin film via the underlying layer, so that the underlying layer comes to function as a reflecting surface, thereby raising a problem in that the mirror effect produced at the Au thin film is lost. Also, when the conventional technique of using a thin film such as SiO₂ or A1₂O₃ as an underlying layer is applied to a reflector for optical communication devices, though the underlying layer does not function as a reflecting surface because the thin film of SiO₂ or A1₂O₃ is transparent to the light that is emitted from the end surface of the waveguide chip, the adhesion strength of the Au thin film to the thin film such as this is not sufficient, so that it is difficult to solve the problem of exfoliation of the Au thin film to a level that can ensure a long-term reliability

### SUMMARY OF THE INVENTION

The invention has been made in view of the aforementioned problems, and an object thereof is to provide an optical communication device having a high reliability with little loss by realizing a method of forming a reflector having an Au thin film layer as a reflecting surface on an optical medium with high adhesion strength.

In order to achieve the aforementioned object, the invention is characterized by having a transparent layer formed on one end surface of an optical medium by using a material to which a metal that forms a chemical bond with gold (Au) is added to a substance that is transparent to the light that propagates through the optical medium, and a gold (Au) thin film layer formed on a front surface of the transparent layer.

Also, in an optical communication device provided with an optical medium that propagates light and a reflector for reflecting the light that has reached one end surface of the optical medium to turn an optical path thereof, the reflector is characterized by having a transparent thin film layer formed on one end surface of the optical medium by using a material to which a metal that forms a chemical bond with gold (Au) is added to a substance that is transparent to the light that propagates through the optical medium, and a gold (Au) thin film layer formed on a front surface of the transparent thin film layer.

Here, the metal added to the material of the transparent thin film layer is preferably a metal that forms an intermetallic compound with gold (Au), a metal that forms a complete solid solution with gold (Au), or a metal having an oxide formation free energy of −6.3×10⁵ joule or below.

In an optical communication device having a construction such as described above, the transparent thin film layer, which is formed on one end surface of the optical medium by using a transparent material to which a metal that forms a chemical bond with gold (Au) is added, will be an underlying layer of the Au thin film layer. Since the transparent thin film layer is substantially transparent to the light that propagates through the optical medium, the transparent thin film layer does not function as a reflecting surface. Therefore, the Au thin film layer will be a reflecting surface that reflects the light coming from the end surface of the optical medium, so that little loss of light occurs at the reflector. Also, near the interface of the transparent thin film layer and the Au thin film layer, the metal added to the transparent thin film layer will be chemically bonded with Au to form an intermetallic compound or a complete solid solution, so that the adhesion strength of the Au thin film layer to the transparent thin film layer will be improved by the bonding force thereof.

As described above, according to the invention, a reflector having an Au thin film layer that undergoes no deterioration by oxidation as a reflecting surface with little loss of light can be formed on an optical medium with high adhesion strength, thereby providing an optical communication device having a high reliability with little loss.

Here, the other objects, features, and advantages of the invention will be apparent by the following description of the embodiments related to the attached drawings.

### BRIEF DESCRIPTION OF THE DRAWINGS

FIG. 1 is a plan view showing a construction example of a principal part of an optical communication device according to the invention;

FIG. 2 is a view showing one example of the transmittance of the transparent thin film layer of the invention relative to the optical wavelength;

FIG. 3 is a plan view showing another construction example of a principal part of an optical communication device according to the invention;

FIG. 4 is a plan view showing one example of an AOTF having a two-stage construction to which the invention is applied;

FIG. 5 is a plan view showing a construction example of a wavelength selection switch to which the AOTF of FIG. 4 is applied; and

FIG. 6 is a view describing a related art for scale reduction of an optical communication device by using a reflector.

### DETAILED DESCRIPTION OF THE INVENTION

Hereafter, best modes for carrying out the invention will be described with reference to the attached drawings. Here, the identical symbols refer to the identical or corresponding parts all throughout the drawings.

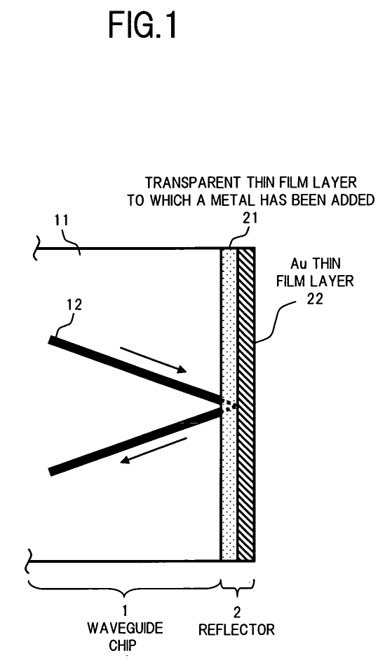

FIG. 1 is a plan view showing a construction of a principal part of an optical communication device according to the first embodiment of the invention.

Referring to FIG. 1, the present optical communication device is provided, for example, with a waveguide chip 1 serving as an optical medium and a reflector 2 formed on one end surface of the waveguide chip 1.

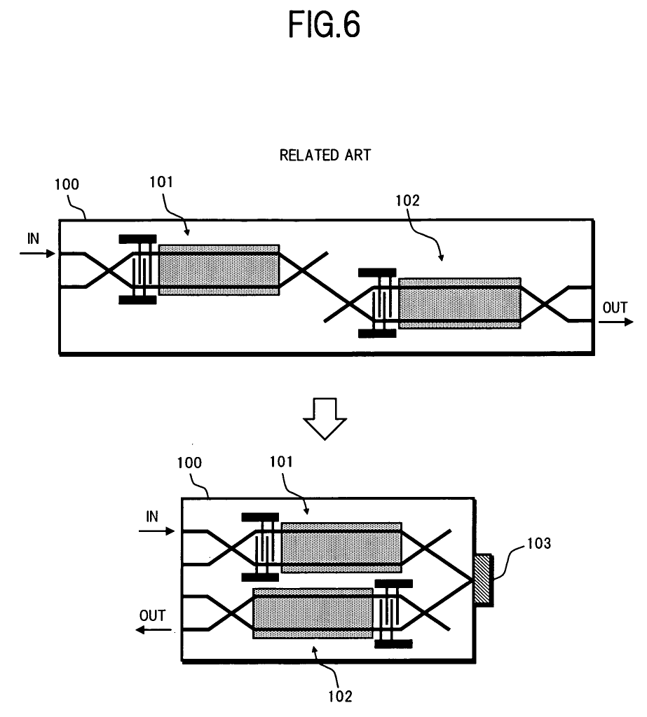

The waveguide chip 1 has a waveguide 12 formed on an optical substrate 11. The scale reduction in the chip size is achieved by turning the waveguide 12 at the end surface of the optical substrate 11 in the same manner as in the above-described case shown in FIG. 6. As a material for the optical substrate 11, one can use, for example, lithium niobate (LiNbO₃), silicon oxide (SiO₂) used in a planar light-wave circuit (PLC), or a gallium arsenic (GaAs) based or indium phosphorus (InP) based optical semiconductor device, or the like.

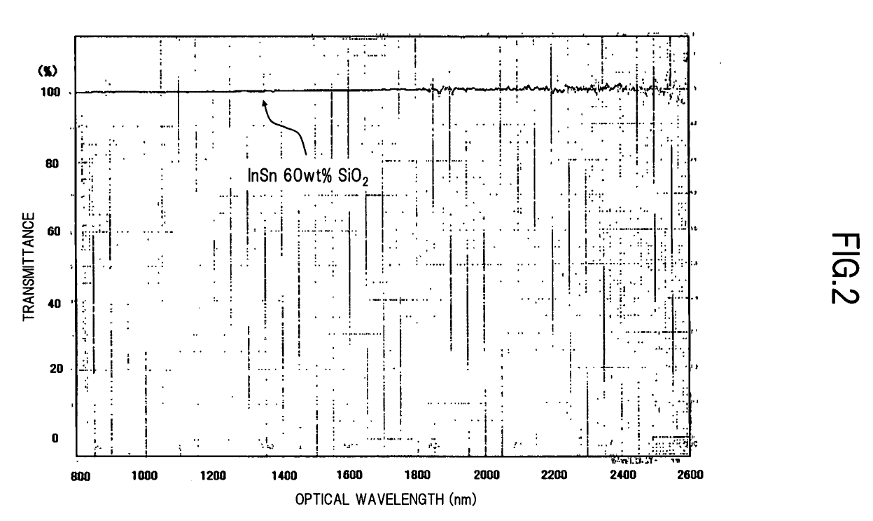

The reflector 2 is made of a transparent thin film layer 21 and a gold (Au) thin film layer 22. With the use of a material to which a metal that forms a chemical bond with Au is added to a substance that is transparent to the light that propagates through the waveguide chip 1, the transparent thin film layer 21 is formed on the end surface where the waveguide 12 of the above optical substrate 11 is turned. The Au thin film layer 22 is formed on the front surface of the transparent thin film layer 21 that is formed on an end surface of the optical substrate 11. Specifically, here, as a material of the above-described transparent thin film layer 21, one can use, for example, a material in which a metal that forms an intermetallic compound with Au is added to silicon oxide (SiO₂) having a high transmittance to the wavelength of general light used for optical communication. The metal that forms an intermetallic compound with Au may be, for example, indium (In), tin (Sn), zinc (Zn), aluminum (Al), gallium (Ga), mercury (Hg), or the like. At least one among these metals is added to SiO₂. The kind and the concentration of the metal added to SiO₂ are set by considering the effect for improvement of the adhesion strength of the Au thin film layer 22 by formation of the intermetallic compound and the transmittance of the transparent thin film layer 21 to the light that propagates through the waveguide chip 1. In other words, the higher the concentration of the added metal is, the more easily the intermetallic compound is formed, whereby the adhesion strength of the Au thin film layer 22 can be increased. However, by the rise in the concentration of the added metal, the transmittance of the transparent thin film layer 21 decreases, whereby the optical loss at the reflector 2 increases. For this reason, a reflector 2 having high adhesion strength with little loss can be formed by raising the concentration of the added metal within a range such that the transparent thin film layer 21 is substantially transparent to the light that propagates through the waveguide chip 1. By raising one specific example, a material obtained by adding In and Sn at a concentration of 60 wt % (weight per cent) to SiO₂ has a transmittance of approximately 100% to the general optical wavelength used for optical communication, as shown in FIG. 2, so that the material is suitable for forming the transparent thin film layer 21. However, it does not mean that the material of the transparent thin film layer 21 used in the invention is limited to the above specific example.

With an optical communication device having a construction such as described above, when the light that propagates through the waveguide 12 of the waveguide chip 1 reaches an end surface of the substrate where the reflector 2 is formed, the light passes through the transparent thin film layer 21 to be reflected by the Au thin film layer 22, and the reflected light is returned to the waveguide 12 of the waveguide chip 1 via the transparent thin film layer 21. During this period, the transparent thin film layer 21 does not function as a reflecting surface because the transparent thin film layer 21 has a high transmittance to the light coming from the waveguide chip 1. On the other hand, the Au thin film layer 22 has a high reflectivity to the light in a wavelength region of 0.6 μm or longer, so that the Au thin film layer 22 functions as a total-reflection mirror to the general light used for optical communication. Also, near the interface of the transparent thin film layer 21 and the Au thin film layer 22, the metal added to the transparent thin film layer 21 is chemically bonded with Au to form an intermetallic compound, so that the adhesion strength of the Au thin film layer 22 to the transparent thin film layer 21 is improved by the bonding force of this intermetallic compound. Here, the adhesion strength of the transparent thin film layer 21 to the end surface of the waveguide chip 1 is further higher than the adhesion strength of the Au thin film layer 22 to the transparent thin film layer 21.

Therefore, according to the first embodiment such as described above, a reflector 2 having an Au thin film layer 22 that undergoes no deterioration by oxidation as a reflecting surface with little loss of light can be formed on an end surface of the waveguide chip 1 with high adhesion strength. Thus, a small-size optical communication device having a high reliability with little loss can be provided.

Next, the second embodiment of the invention will be described.

In an optical communication device according to the second embodiment, a reflector 2 made of a transparent thin film layer 21 and an Au thin film layer 22 is formed on an end surface of a waveguide chip 1, in the same manner as in the construction of the above-described first embodiment shown in FIG. 1. The difference from the construction of the first embodiment lies in that the metal added to SiO₂ as a material of the transparent thin film layer 21 is a metal that forms a complete solid solution with Au.

The metal that forms a complete solid solution with Au may be, for example, silver (Ag), platinum (Pt), or the like. At least one among these metals is added to SiO₂. The kind and the concentration of the metal added to SiO₂ are set by considering the effect for improvement of the adhesion strength of the Au thin film layer 22 and the transmittance of the transparent thin film layer 21, in the same manner as in the first embodiment.

When the transparent thin film layer 21 is formed with the use of a material such as described above, a complete solid solution of Au with Ag or Pt is formed near the interface between the transparent thin film layer 21 and the Au thin film layer 22, whereby the adhesion strength of the Au thin film layer 22 to the transparent thin film layer 21 is improved by the bonding force of this complete solid solution. Therefore, even when the transparent thin film layer 21 is formed with the use of a material in which a metal that forms a complete solid solution with Au is added to SiO₂, the same effect as in the above-described first embodiment can be obtained.

Next, the third embodiment of the invention will be described.

In an optical communication device according to the third embodiment, a reflector 2 made of a transparent thin film layer 21 and an Au thin film layer 22 is formed on an end surface of a waveguide chip 1, in the same manner as in the construction of the above-described first embodiment shown in FIG. 1. The difference from the construction of the first embodiment lies in that the metal added to SiO₂ as a material of the transparent thin film layer 21 is a metal having an oxide formation free energy of −6.3×10⁵ joule (=−150 kcal) or below.

The oxide formation free energy represents the reactivity of a metal to oxygen. A metal having a smaller value thereof, i.e. a metal that is more liable to be oxidized, has a stronger interfacial bond. Considering the interfacial bond with the Au thin film layer 22, when a metal having an oxide formation free energy of −6.3×10⁵ joule or below is contained in the transparent thin film layer 21, the metallic bond with Au is formed more easily. The metal having an oxide formation free energy of −6.3×10⁵ joule or below may be, for example, titanium (Ti), chromium (Cr), molybdenum (Mo) or the like. At least one among these metals is added to SiO₂. Here, the oxide formation free energy of Ti is −8.6×10⁵ joule (=−204 kcal); the oxide formation free energy of Cr is −10.5×10⁵ joule (=−250 kcal); and the oxide formation free energy of Mo is −6.8×10⁵ joule (=−162 kcal). The kind and the concentration of the metal added to SiO₂ are set by considering the effect for improvement of the adhesion strength of the Au thin film layer 22 and the transmittance of the transparent thin film layer 21, in the same manner as in the first embodiment.

When the transparent thin film layer 21 is formed with the use of a material such as described above, the adhesion strength of the Au thin film layer 22 to the transparent thin film layer 21 will be improved by the metallic bond formed near the interface between the transparent thin film layer 21 and the Au thin film layer 22. Therefore, even when the transparent thin film layer 21 is formed with the use of a material in which a metal having an oxide formation free energy of −6.3×10⁵ joule or below is added to SiO₂, the same effect as in the above-described first embodiment can be obtained.

Here, in the above-described first to third embodiments, one example has been shown in which SiO₂ is used as a principal material for forming the transparent thin film layer 21; however, the invention is not limited to this example, so that a transparent material such as aluminum oxide (Al₂O₃) can be used as well.

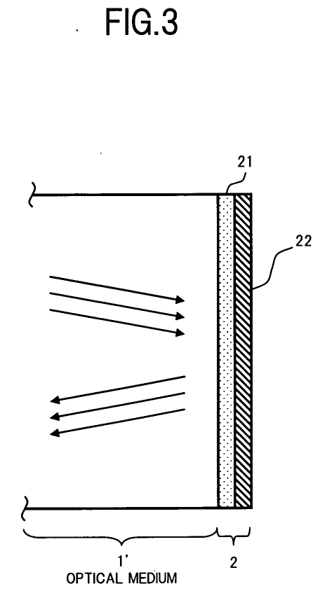

Also, a construction example has been shown in which a reflector 2 is formed on an end surface of a waveguide chip 1 where a waveguide 12 is formed on an optical substrate 11. Alternatively, for example, referring to FIG. 3, a reflector 2 may be formed on an end surface of an optical medium 1′ where no specific waveguide is formed, whereby the light propagating through the optical medium 1′ towards the above-described end surface may be reflected by the Au thin film layer 22 of the reflector 2 to turn the propagation direction thereof. A specific example of the optical medium 1′ where no waveguide such as described above is formed may be an optical crystal, a semiconductor laser chip, a slab waveguide substrate, or the like.

Next, specific application examples of an optical communication device of the above-described first to third embodiments will be described.

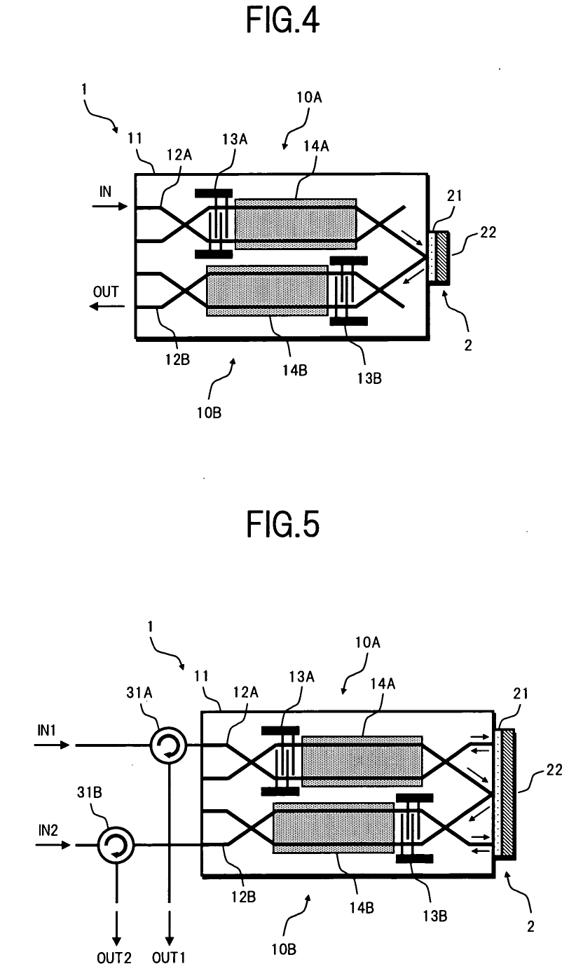

FIG. 4 is a plan view showing one example in which the invention is applied to an acousto-optic tunable filter (AOTF) having a two-stage construction.

Referring to FIG. 4, a first functional device section 10A and a second functional device section 10B are formed on a waveguide chip 1. The functional device sections 10A, 10B respectively have, for example, Mach-Zender type waveguides 12A, 12B formed on a LiNbO3 substrate 11, interdigital transducers (IDT) 13A, 13B for generating a surface acoustic wave (SAW) on the substrate 11, and SAW guides 14A, 14B for allowing the SAW generated in the IDT 13A, 13B to propagate along the waveguides 12A, 12B. The waveguide connecting an output of the functional device section 10A and an input of the functional device section 10B is turned at one end surface of the substrate 11, and a reflector 2 made of a transparent thin film layer 21 and an Au thin film layer 22 is formed near the end surface where the waveguide is located.

With the AOTF having a construction such as described above, a WDM light obtained by multiplication of a plurality of optical signals having different wavelengths is input into the functional device section 10A and propagates through each arm of the Mach-Zender type waveguide 12A. During this period, an RF signal having a predetermined frequency is applied to the IDT 13A, and a SAW generated in accordance with the RF signal propagates along each arm by the SAW guide 14A. By an acousto-optic effect of this SAW, an optical signal having a wavelength corresponding to the frequency of the RF signal is selected from the WDM light to be output from the functional device section 10A. The output light of the functional device section 10A propagates through the waveguide to reach the substrate end surface and passes through the transparent thin film layer 21 of the reflector 2 to be reflected by the Au thin film layer 22. The light reflected by the Au thin film layer 22 passes through the transparent thin film layer 21 to be sent to the functional device section 10B on the output side, whereby an optical signal having a wavelength corresponding to the frequency of the RF signal applied to the IDT 13B is selected to be output from the functional device section 10B, in the same manner as in the functional device section 10A on the input side.

FIG. 5 is a plan view showing one example in which a wavelength selection switch is constructed by further applying the above-described AOTF having a two-stage construction shown in FIG. 4. Here, a basic construction of a wavelength selection switch using an AOTF having a two-stage construction is known, for example, by Japanese Patent Application National Publication (Laid-Open) No. 2003-508795, so that a schematic description thereof will be given here.

In a construction example of a wavelength selection switch shown in FIG. 5, not only the waveguide that connects between the first and second functional device sections 10A, 10B but also the waveguides respectively linked to the output of the first functional device section 10A and the input of the second functional device section 10B, which are unused ports in the construction of FIG. 4, are extended to one end surface of the substrate 11, and a reflector 2 is formed to include a range of the end surface where each waveguide is located. Also, optical circulators 31A, 31B are connected to the input and output ports of the waveguide chip 1, and the WDM light is input and output to and from the first and second functional device sections 10A, 10B via the optical circulators 31A, 31B.

With the wavelength selection switch having a construction such as described above, the WDM light that is input from an input port IN1 located on the upper left side of FIG. 5, for example, is given to the first functional device section 10A via the optical circulator 31A. In the first functional device section 10A, an optical signal having a wavelength corresponding to the frequency of an RF signal applied to the IDT 13A is selected to be output from a port on the lower side in FIG. 5, and is reflected by the reflector 2 at the substrate end surface to be sent to the second functional device section 10B, and passes through the second functional device section 10B and the optical circulator 31B to be output from an output port OUT2. On the other hand, the optical signal that is not selected by the first functional device section 10A is output from a port on the upper side in FIG. 5, and is reflected by the reflector 2 at the substrate end surface to be returned to the first functional device section 10A, and passes through the first functional device section 10A and the optical circulator 31A to be output from an output port OUT1.

Meanwhile, the WDM light that is input from an input port IN2 located on the lower left side of FIG. 5 is given to the second functional device section 10B via the optical circulator 31B. In the second functional device section 10B, an optical signal having a wavelength corresponding to the frequency of an RF signal applied to the IDT 13B is selected to be output from a port on the upper side in FIG. 5, and is reflected by the reflector 2 at the substrate end surface to be sent to the first functional device section 10A, and passes through the first functional device section 10A and the optical circulator 31A to be output from the output port OUT1. On the other hand, the optical signal that is not selected by the second functional device section 10B is output from a port on the lower side in FIG. 5, and is reflected by the reflector 2 at the substrate end surface to be returned to the second functional device section 10B, and passes through the second functional device section 10B and the optical circulator 31B to be output from the output port OUT2.

Here, in the application examples shown in FIGS. 4 and 5, an example has been shown in which an AOTF is used as a functional device section; however, the invention is effective also in a case in which various functional device sections other than an AOTF are connected in series.

What is claimed is:

1. An optical communication device provided with an optical medium that propagates light and a reflector for reflecting the light that has reached one end surface of the optical medium to turn an optical path thereof, wherein said reflector includes:
a transparent thin film layer formed on one end surface of said optical medium by using a material to which a metal that forms a chemical bond with gold (Au) is added to a substance that is transparent to the light that propagates through said optical medium; and
a gold (Au) thin film layer formed on a front surface of the transparent thin film layer.

2. The optical communication device of claim 1, wherein the metal added to the material of said transparent thin film layer is a metal that forms an intermetallic compound with gold (Au).

3. The optical communication device of claim 2, wherein said metal that forms an intermetallic compound with gold (Au) is at least one selected from the group consisting of indium (In), tin (Sn), zinc (Zn), aluminum (Al), gallium (Ga), mercury (Hg), and lead (Pb).

4. The optical communication device of claim 1, wherein the metal added to the material of said transparent thin film layer is a metal that forms a complete solid solution with gold (Au).

5. The optical communication device of claim 4, wherein said metal that forms a complete solid solution with gold (Au) is at least one of silver (Ag) and platinum (Pt).

6. The optical communication device of claim 1, wherein the metal added to the material of said transparent thin film layer is a metal having an oxide formation free energy of −6.3×10⁵ joule or below.

7. The optical communication device of claim 6, wherein said metal having an oxide formation free energy of −6.3×10⁵ joule or below is at least one of titanium (Ti), chromium (Cr), and molybdenum (Mo).

8. The optical communication device of claim 1, wherein the substance that is used as the material of said transparent thin film layer and transparent to the light that propagates through said optical medium is any one of silicon oxide (SiO₂) and aluminum oxide (Al₂O₃).

9. The optical communication device of claim 1, wherein
said optical medium is an optical substrate on which a waveguide that propagates the light is formed, and
said reflector is formed on an end surface at which the waveguide of said optical substrate is located.

10. The optical communication device of claim 9, wherein
said optical substrate has a first functional device section and a second functional device section that perform predetermined processes on the light that propagates through said waveguide, and
said reflector reflects the light that is processed by said first functional device section and gives the reflected light to said second functional device section.

11. The optical communication device of claim 10, wherein said first and second functional device sections are acousto-optic tunable filters.

12. An optical communication device comprising:
a transparent layer formed on one end surface of an optical medium by using a material to which a metal that forms a chemical bond with gold (Au) is added to a substance that is transparent to light that propagates through said optical medium; and
a gold (Au) thin film layer formed on a front surface of the transparent layer.

13. A method for forming, in an optical communication device in which light propagates through an optical medium, a reflector for reflecting the light that has reached one end surface of said optical medium to turn an optical path thereof, said method comprising:
forming a transparent thin film layer on one end surface of said optical medium by using a material to which a metal that forms a chemical bond with gold (Au) is added to a substance that is transparent to the light that propagates through said optical medium; and
forming a gold (Au) thin film layer on a front surface of the formed transparent thin film layer.

14. The method for forming a reflector in an optical communication device of claim 13, wherein the metal added to the material of said transparent thin film layer is a metal that forms an intermetallic compound with gold (Au).

15. The method for forming a reflector in an optical communication device of claim 14, wherein said metal that forms an intermetallic compound with gold (Au) is at least one selected from the group consisting of indium (In), tin (Sn), zinc (Zn), aluminum (Al), gallium (Ga), mercury (Hg), and lead (Pb).

16. The method for forming a reflector in an optical communication device of claim 13, wherein the metal added to the material of said transparent thin film layer is a metal that forms a complete solid solution with gold (Au).

17. The method for forming a reflector in an optical communication device of claim 16, wherein said metal that forms a complete solid solution with gold (Au) is at least one of silver (Ag) and platinum (Pt).

18. The method for forming a reflector in an optical communication device of claim 13, wherein the metal added to the material of said transparent thin film layer is a metal having an oxide formation free energy of −6.3×10⁵ joule or below.

19. The method for forming a reflector in an optical communication device of claim 18, wherein said metal having an oxide formation free energy of −6.3×10⁵ joule or below is at least one of titanium (Ti), chromium (Cr), and molybdenum (Mo).

20. The method for forming a reflector in an optical communication device of claim 13, wherein the substance that is used as the material of said transparent thin film layer and transparent to the light that propagates through said optical medium is any one of silicon oxide (SiO₂) and aluminum oxide (Al₂O₃).
